(19) United States
(12) Patent Application Publication
(10) Pub. No.: US 2006/0023365 A1
(43) Pub. Date: Feb. 2, 2006

(54) Disk apparatus having housing modification to prevent sticking of latch magnet

(75) Inventors: Tomoyuki Tokizaki, Ome-shi (JP); Toshikuni Sato, Fussa-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 11/054,849

(22) Filed: Feb. 9, 2005

(30) Foreign Application Priority Data
Jul. 30, 2004 (JP) 2004-224700

(51) Int. Cl. G11B 5/54

(52) U.S. Cl. 360/256.2

(57) ABSTRACT

An HDD has a latch mechanism which locks a carriage having a read/write head at a retreated position. The latch mechanism has a latch arm which has a claw to engage with a projection of the carriage. A permanent magnet is embedded in a rear end of the latch arm, and receives a magnetic force from an electromagnet fixed to the housing. An opening is formed in a region of the housing adjacent the permanent magnet, preventing the permanent magnet from being stuck to the housing which is at least partially made of magnetic material.

### CROSS-REFERENCE TO RELATED APPLICATIONS

This application is based upon and claims the benefit of priority from prior Japanese Patent Application No. 2004-224700, filed Jul. 30, 2004, the entire contents of which are incorporated herein by reference.

### BACKGROUND OF THE INVENTION

1. Field of the Invention

The present invention relates to a disk apparatus which stores and reproduces information on/from a disk-shaped medium.

2. Description of the Related Art

Recently, disk apparatuses such as magnetic and optical disk apparatuses have been widely used as external recording units or image recording units of computers.

For example, a magnetic disk apparatus usually has a rectangular housing. The housing contains a magnetic disk, a spindle motor to support and rotate the magnetic disk, magnetic heads to write and read information to/from the magnetic disk, a head actuator to support the magnetic heads movably against the magnetic disk, a voice coil motor to rotate and position the head actuator, and a board unit having a head IC, etc.

The housing also contains a ramp load mechanism to place the head actuator in a retreated position wherein the magnetic head is retreated to a position away from the magnetic disk, and a latch mechanism to prevent accidental disengagement of the head actuator from the retreated position.

In a known latch mechanism, a latch lever having a rotation axis orthogonal to the rotation axis of the head actuator is provided, a permanent magnet is attached to the latch lever, and an electromagnet with a core is fixed to the housing opposite to the permanent magnet. (Refer to Jpn. Pat. Appln. KOKOAI Publication No. 2003-68038 (paragraph 0006).)

However, this kind of latch mechanism with a permanent magnet attached to a latch lever causes a malfunction of the latch lever. The latch lever may not work normally, because an undesired magnetic force acts on the permanent magnet as a result of magnetic flux leaked from the voice coil motor which drives the head actuator or by the influence of magnetic substance disposed around the head actuator. If the latch lever does not work normally, the head actuator disengages from the retreated position while the magnetic disk is stationary, and head sticks to the stationary magnetic disk, causing the serious problem of losing recorded data.

### BRIEF SUMMARY OF THE INVENTION

It is an object of the invention is to provide a disk apparatus having a latch mechanism attaining high reliability.

In order to achieve the above object, a disk apparatus according to an embodiment of the present invention comprises a housing which is at least partially made of a magnetic material, a disk-shaped medium provided rotatably in the housing, a head to record and reproduce information on/from the medium, an actuator to move the head along the medium, and a latch mechanism to lock the actuator at a retreated position to hold the head at a position away from the medium. The latch mechanism has a latch arm provided movably between a first position to lock the actuator at the retreated position and a second position to allow movement of the actuator from the retreated position. There is also provided a permanent magnet fixed to the latch arm, a current-controllable electromagnet to move the latch arm between the first and second positions, and an opening formed in a region of the housing adjacent the permanent magnet.

According to an embodiment of the invention, an opening is formed in a region of the magnetic material housing adjacent the permanent magnet, and when the permanent magnet comes close to the housing, the permanent magnet is prevented from being stuck to the housing by a magnetic force, and so from causing a malfunction of the latch arm.

The disk apparatus according to an embodiment of the invention comprises a housing which is at least partially made of a magnetic material, a disk-shaped medium provided rotatably in the housing, a head to record and reproduce information on/from the medium, an actuator to move the head along the medium, and a latch mechanism to lock the actuator at a retreated position to hold the head at a position away from the medium. The latch mechanism has a latch arm provided movably between a first position to lock the actuator at the retreated position and a second position to allow movement of the actuator from the retreated position, a permanent magnet fixed to the latch arm, and a current-controllable electromagnet to move the latch arm between the first and second positions. A region of the housing adjacent the permanent magnet is made of non-magnetic material.

According to an embodiment of the invention, a region of the housing adjacent the permanent magnet provided in the latch arm of the latch mechanism is made of a non-magnetic material, and when the permanent magnet comes close to the housing, the permanent magnet is prevented from being stuck to the housing by a magnetic force, and so from causing a malfunction of the latch arm.

Embodiments of the invention may also be understood as a method of eliminating sticking of a locking arm to a housing of a disk apparatus having a disk-shaped medium rotatably mounted in the housing, a suspension having a read/write head for the medium and a magnet forming part of the locking arm, the locking arm serving to release said suspension for permitting said read/write head to access said medium in an operating state and to lock said suspension to prevent said suspension from permitting said read/write head to access said medium in a non-operating state. The method comprising the step of providing an opening in a portion of the housing adjacent the magnet or alternately of constructing a portion of the housing adjacent the magnet of a non-magnetic material.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an HDD according to an embodiment of the present invention;

FIG. 2 is a disassembled perspective view of the HDD of FIG. 1;

FIG. 3 is a plane view showing the housing and internal structure of the HDD of FIG. 2;

FIG. 4 is a perspective view showing the control circuit board side of the HDD of FIG. 1;

FIG. 5 is a sectional view of the HDD taken along lines A-A of FIG. 1;

FIG. 6 is a schematic illustration showing the internal structure of the HDD including a latch mechanism according to a first embodiment of the invention;

FIGS. 7A and 7B are partially magnified sectional views taken along lines VII-VII of FIG. 6;

FIG. 8 is a partially magnified section view showing a latch mechanism according to a second embodiment of the invention;

FIG. 9 is a partially magnified section view showing a latch mechanism according to a third embodiment of the invention; and

FIG. 10 is a partially magnified section view showing a latch mechanism according to a fourth embodiment of the invention.

### DETAILED DESCRIPTION OF THE INVENTION

Detailed description will be given on a hard disk drive (hereinafter referred to as an HDD) as a disk apparatus according to an embodiment of the present invention hereinafter with reference to the accompanied drawings.

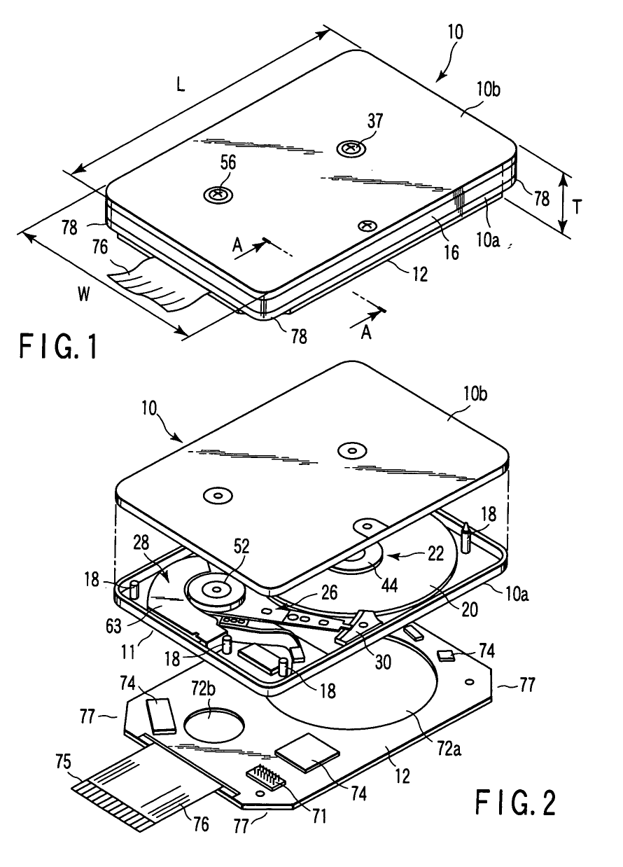

As shown in FIGS. 1 and 2, the HDD has a substantially rectangular box-shaped housing 10 which contains various members described later, and a substantially rectangular control circuit board 12 which is provided by being laid under the outside of the housing 10. The housing 10 and control circuit board 12 are formed to be 32 mm long and 24 mm wide, for example. The thickness T of the housing and control circuit board is set to 3.3 mm or 5 mm depending on the number of disks to be housed.

As shown in FIGS. 2 to 5, the housing 10 consists of a first shell 10a and a second shell 10b, which are formed to have substantially equal dimensions. The first and second shells 10a and 10b are made of magnetic material in a substantially rectangular shape, and have sidewalls standing in the peripheral edge portions. The first and second shells 10a and 10b face each other in the state that the edge portions are opposed. A belt-shaped sealing material 16 is wound around the peripheral edge portions of the first and second shells 10a and 10b. The sealing material connects the peripheral edge portions and seals the clearance between the edge portions. This makes the housing 10 as an airtight rectangular box.

The bottom of the first shell 10a forms a substantially rectangular mounting base 11. Four corners of the housing 10 including the corners of the mounting base 11 are rounded. With this structure, the sealing material 16 wound around the peripheral edge portions of the housing 10 is prevented from being damaged at the corners of the housing, and deterioration of the air-tightness due to lifting of the sealing material is prevented.

In the housing 10, support posts 18 are provided in the peripheral edge portion of the housing. Each support post 18 has a proximal end fixed to the inside surface of the first shell 10a, and set up substantially vertical to the inside of the first shell 10a. At the position of each support post 18, a screw hole is formed from the mounting base 11 and extended into the support post.

The housing 10 contains a magnetic disk 20 with the diameter of 0.85 inches which serves as a disk-shaped medium, a spindle motor 22 which supports and rotates the magnetic disk, a magnetic head which writes and reads data to/from the magnetic disk, a carriage 26 (head actuator) which supports the magnetic head movably against the magnetic disk 20, a voice coil motor (hereinafter referred as a VCM) 28 as a driving motor which rotates and positions the carriage 26, a ramp load mechanism 30 which unloads to and places the magnetic head in a position separated from the magnetic disk when the magnetic head moves to the peripheral edge portion of the magnetic disk, a latch mechanism 32 which holds the carriage 26 at a retreated position, and a board unit 34 which has a head IC, etc.

The magnetic head 24 has an air bearing surface, and can move smoothly while floating on the rotating magnetic disk 20. However, if the magnetic head 24 is opposed to the stationary magnetic disk 20, the data recorded on the magnetic disk 20 may be damaged.

The spindle motor 22 is fixed to the first shell 1a. The spindle motor 22 has an axis 36. The axis 36 is fixed to the inner surface of the first shell 10a, and set up substantially vertical to the inner surface. The extended end of the axis 36 is fixed to the second shell 10b by a fixing screw 37 inserted from the outside of the second shell 10b. Thus, the axis 36 is supported from both sides by the first and second shells 10a and 10b.

A rotor is rotatably supported by the axis 36 through a bearing (not shown). The end portion of the rotor in the second shell 10b side constitutes a columnar hub 43. The magnetic disk 20 is coaxially fit in the hub 43. An annular clamp ring 44 is fit to the end portion of the hub 43, and holds the magnetic disk 20. Thus, the magnetic disk 20 is supported rotatably as one body with the rotor.

An annular permanent magnet (not shown) is fixed to the end portion of the rotor in the first shell 10a side, and located coaxially with the rotor. The spindle motor 22 has a stator core fixed to the first shell 10a, and coils wound around the stator core. The stator core and coils are disposed outside the permanent magnet with a gap.

The carriage 26 (head actuator) has a bearing assembly 52 fixed to the inner surface of the first shell 10a. The bearing assembly 52 has an axis 53 set up vertically against the inner surface of the first shell 10a, and a columnar hub 54 supported rotatably by the axis through a pair of bearings. The extended end of the axis 53 is fixed to the second shell 10b by a fixing screw 56 inserted from the outside of the second shell 10b. Thus, the axis 53 is supported from both sides by the first and second shells 10a and 10b. The bearing assembly 52 serving as a bearing is provided in the length direction of the housing 10 side by side with the spindle motor 22.

The carriage 26 has an arm 58 extended from the hub 54, a slender plate-shaped suspension 60, and a support frame 62 extended from the hub 54 in the opposite direction to the arm 58. The magnetic head 24 is supported at the extended end of the suspension 60 through a gimbal (not shown). The magnetic head 24 is given a certain head load by the spring force of the suspension 60 toward the surface of the magnetic disk 20. A voice coil 64 constituting a VCM 28 is integrally fixed to the support frame 62.

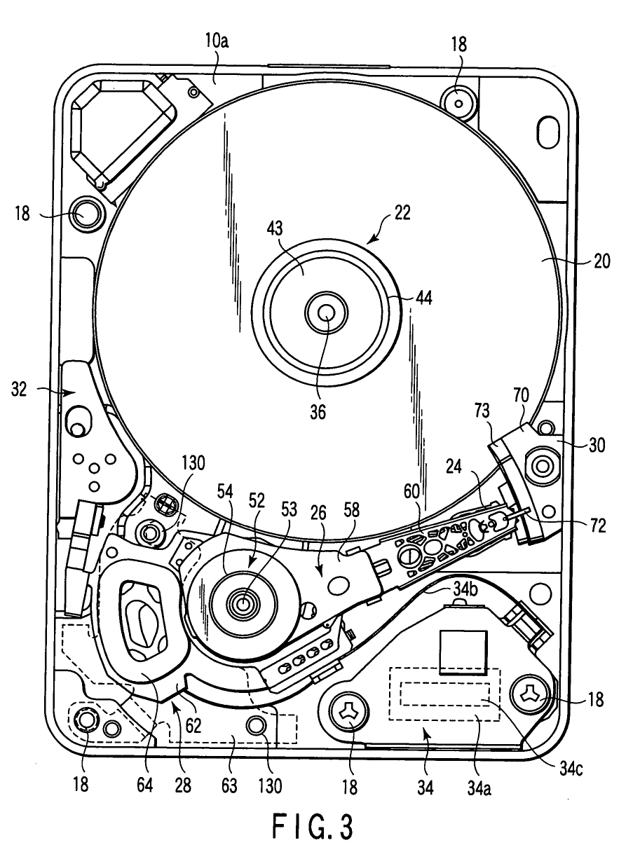

The VCM 28 which rotates the carriage 26 around the bearing assembly 52 has a pair of yokes 63 fixed to the first shell 10a and opposed each other with a gap, and a magnet (not shown) fixed to the inner surface of one of the yoke and opposed to the voice coil 64. By energizing the voice coil 64, the carriage 26 is rotated between the retreated position shown in FIG. 3 and the operating position to place the magnetic head 24 on the surface of the magnetic disk 20, and the magnetic head 24 is positioned above a desired track of the magnetic disk 20. The movable range of the carriage 26 is limited by two stoppers 130 shown in FIG. 3.

The latch mechanism 32 fixed to the first shell 10a latches (locks) the carriage 26 moved to the retreated position, and prevents the carriage 26 from moving to the operating position from the retreated position when the stopped HDD receives a physical shock from the outside.

The ramp load mechanism 30 has a ramp member 70 which is fixed to the inner surface of the first shell 10a and opposed to the peripheral edge portion of the magnetic disk 20, and a tab 72 which is extended from the distal end of the suspension 60 and serves as an engagement member. The ramp member 70 is molded from resin, and has a ramp surface 73 that can be engaged with the tab 72. When the carriage 26 is rotated from the internal circumference of the magnetic disk 20 to the retreated position in the outer circumference of the magnetic disk 20, the tab 72 engages with the ramp surface 73, rises along the ramp surface slope, and unloads the magnetic head 24. When the carriage is rotated to the retreated position, the tab 72 is supported on the ramp surface 73 of the ramp member 70, and the magnetic head 24 is held at a distance from the surface of the magnetic disk 20.

The board unit 34 has a main body 34a composed of a flexible printed circuit board. The main body 34a is fixed to the inner surface of the first shell 10a. On the main body 34a, electronic components such as a head IC and head amplifier are mounted. The board unit 34 has a main flexible printed circuit board (hereinafter referred as a main FPC) 34b extended from the main body 34a. The extended end of the main FPC 34b is connected in proximity to the bearing assembly 52, and further electrically connected to the magnetic head 24 through a cable (not shown) provided on the arm 58 and suspension 60. At the bottom of the main body 34a of the board unit 34, a connector 34c is mounted to connect to the control circuit board 12. The connector 34c is exposed to the mounting surface 11 of the first shell 10a through the opening formed in the first shell 10a.

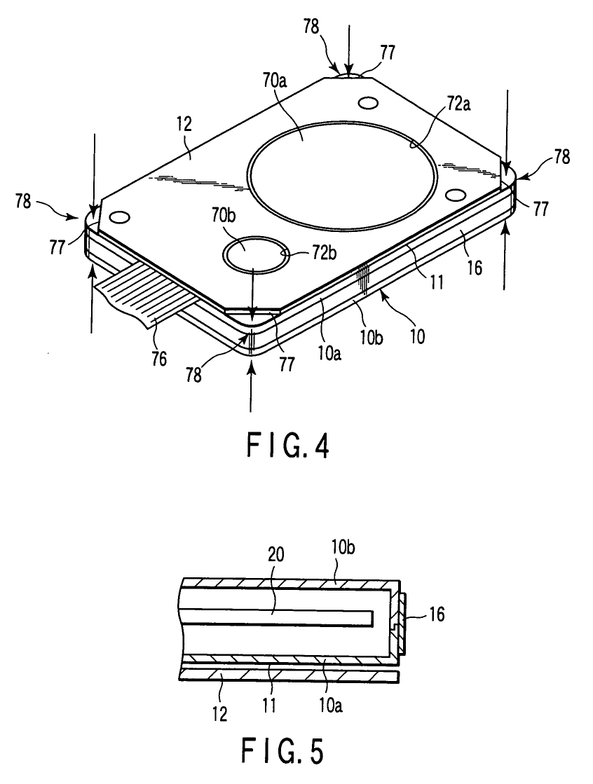

As shown in FIGS. 2 and 4, the control circuit board 12 composed of a printed circuit board has a substantially rectangular shape with the length and width almost equal to the mounting surface 11 of the housing 10. On the mounting surface 11 of the housing 10, a circular projection 70a corresponding to the spindle motor 22 and a circular projection 70b corresponding to the bearing assembly 52 are formed. In the control circuit board 12, circular openings 72a and 72b corresponding to the projections 70a and 70b are formed.

Each of the four corners of the control circuit board 12 is cut obliquely at angle of 45°, for example, with respect to each side and forms a cutout portion 77. A plurality of electronic components 74 and connector 71 are mounted on the inner surface of the control circuit board 12, that is, on the surface opposite to the housing 10. The control circuit board 12 is connected with a flexible printed circuit board 76 for electrically connecting the HDD. The flexible printed circuit board 76 is extended outward from one short side of the control circuit board 12. A plurality of connection terminals 75 is formed at the extended end of the flexible printed circuit board 76.

The control circuit board 12 configured as described above is laid under the mounting surface 11 of the housing 10, and fixed to the first shell 10a with screws. The control circuit board 12 is placed in the state that the four sides are aligned with or adjusted to the four sides of the mounting surface 11. The projections 70a and 70b formed on the mounting surface 11 are fit in the openings 72a and 72b of the control circuit board 12. The connector 71 mounted on the control circuit board 12 is connected to the connector 34c of the board unit 34.

The cutouts 77 formed at the four corners of the control circuit board 12 are placed in the four corners of the mounting surface 11. Thus, the four corners of the mounting surface 11 are exposed to the outside without being covered by the control circuit board 12. The corners of the housing 10 including the four exposed corners of the mounting surface 11 form holding portions 78 to hold the housing without contacting the control circuit board 12.

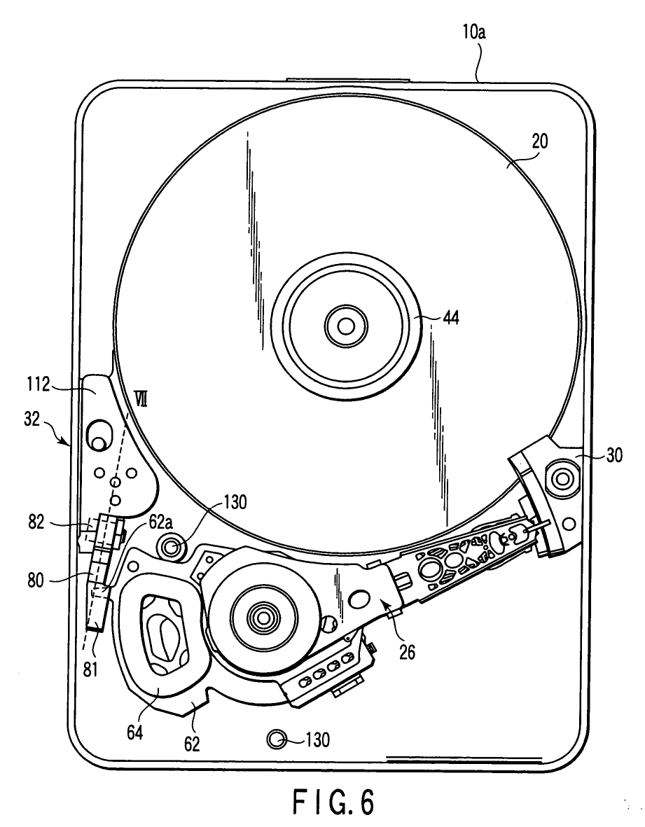

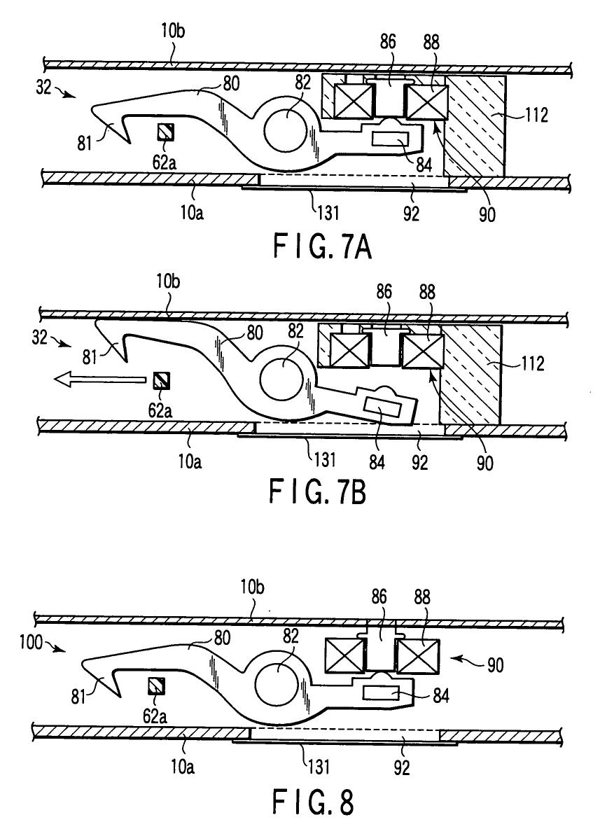

Next, detailed description will be given on the latch mechanism 32 according to the first embodiment of the invention with reference to the FIG. 6 and the schematic illustrations of FIGS. 7A and 7B. FIG. 6 shows the simplified structure of the essential part of the invention, including the internal structure of HDD with the yokes 63 of VCM 28 and magnet omitted. FIGS. 7A and 7B are the schematic cross sections taken along lines VII-VII of FIG. 6 for explaining the operation of the latch mechanism 32.

The latch mechanism 32 has a latch arm 80 fixed with a pin 82 rotatably with respect to a support member 112 secured to the first shell 10a. Namely, the front and rear ends of the latch arm 80 are fixed rotatably in the direction of separating from and close to the first and second shells 10a and 10b.

A claw 81 is projected at the front end of the latch arm 80. The claw 81 engages with the projection 62a at the rear end of the support frame 62 of the carriage 26. Namely, the claw 81 is positioned for engagement with the projection 62a of the support frame 62 when the latch arm 80 is rotated to the latch position shown in FIG. 7A. When the latch arm 80 is in the latch position shown in FIG. 7A, a small rotation of the support frame 62 in the counter-clockwise direction as viewed from FIG. 6 (corresponding to a movement of the projection 62a to the left in FIG. 7A) will cause the projection 62a to make contact with the claw 81 and prevent any further counter-clockwise rotation of the projection 62 and the support frame 62 and thus prevent any further rotation of the carriage 26 and suspension 60. Thus, in the latched position of the latch arm 80 as shown in FIG. 7A, the carriage 26 is prevented from moving to the operating position (not shown) from the retreated position shown in FIG. 6. The carriage 26 is allowed to move to the operating position when the latch arm 80 is rotated to the release position shown in FIG. 7B. As indicated earlier, the operating position of the carriage 26 is such as to place the magnetic head 24 on the surface of the magnetic disk 20, so as to position the magnetic head 24 above a desired track of the magnetic disk 20.

A permanent magnet 84 is embedded in the rear end of the latch arm 80. An electromagnet 90 is secured, by means of the support member 112 attached to first shell 10a, at a position opposite to the permanent magnet 84. The electromagnet 90 has a core 86 which is made of magnetic material and a winding 88. The electromagnet 90 generates a controllable magnetic field for the permanent magnet 84 embedded in the end of the latch arm 80.

An opening 92 penetrating the first shell 10a is formed in a region of the first shell 10a where the permanent magnet 84 is moved close to by the latch arm 80 as shown in FIG. 7B. The position and shape of the opening 92 are set so that when the permanent magnet 84 is moved close to that region, at least the permanent magnet 84 is not effected by an undesirable magnetic force. Thus, when the latch arm 80 is rotated to the release position shown in FIG. 7B, the permanent magnet 84 is prevented from being attracted or stuck to the first shell 10a by a magnetic force and the latch mechanism 32 is prevented from malfunctioning. A sealing member 131 made of non-magnetic material is stuck to the opening 92 to keep the inside of the housing 10 airtight.

The latch mechanism 32 constructed as above operates as follows.

For example, if a current is not applied to the winding 88 of the electromagnet 90, an attractive force acts between the core 86 which is made of magnetic material and permanent magnet 84, the latch arm 80 is placed in the latch position as shown in FIG. 7A, and the claw 81 at the front end of the latch arm 80 can engage with the projection 62a of the support frame 62. If the carriage 26 starts to move from the retreated position to the operating position in this state, the projection 62a of the support frame 62 engages with the claw 81, the movement of the carriage 26 is limited, and the carriage 26 is essentially locked at the retreated or latched position.

In contrast, if a certain current is applied to the winding 88 of the electromagnet 90 in an appropriate direction of generating a magnetic field in the direction repelling the permanent magnet 84, a repulsive force acts between the permanent magnet 84 and electromagnet 90, and the latch arm 80 is moved to the release position. In this state, the carriage 26 is allowed to move from the retreated position to the operating position.

When the latch arm 80 is moved to the release position, the claw 81 of the latch arm 80 is moved away from the latch position, and at the same time, the permanent magnet 84 is moved toward the first shell 10a. In this embodiment, since the opening 92 is formed in a region of the first shell 10a to which the permanent magnet 84 is moved, the permanent magnet 84 is not affected by an undesired magnetic field and the latch arm 80 is naturally returned to the latch position when the current is stopped by virtue of the attractive force of the permanent magnet 84 to the core 86.

However, if the opening 92 is not formed in the above-mentioned region of the first shell 10a, when the permanent magnet 84 is moved close to the first shell 10a by the operation of the latch arm 80, the permanent magnet 84 may be attracted or stuck to the first shell 10a by a magnetic force. If the permanent magnet 84 is stuck to the first shell 10a by a magnetic force, even if the current to the winding 88 of the electromagnet 90 is stopped, the rear end of the latch arm 80 is left fixed at the position close to the first shell 10a, and the latch arm 80 remains stuck in the release position and may not be operated.

Thus, in this embodiment, the opening 92 is formed in a region of the first shell 10a to which the permanent magnet 84 is moved close, so that the permanent magnet 84 is not affected by an undesired magnetic force.

As described above, according to this embodiment, as the opening 92 is formed in a region of the first shell 10a to which the permanent magnet 84 is moved when the latch arm 80 is operated, the latch arm 80 is prevented from malfunctioning when the permanent magnet 84 is moved close to the first shell 10a. This realizes the latch mechanism 32 with high reliability.

According to this embodiment, when the latch mechanism 32 is assembled, it is possible to support the latch arm 80 by a jig inserted from the opening 92 to improve workability. It is also possible to confirm the latch mechanism 32 by visual inspection from the outside of the first shell 10a through the opening 92. This can easily confirm after assembling whether the latch mechanism 32 operates normally. The sealing member 131 may be stuck to cover the opening 92 after confirming the operation of the latch mechanism 32.

FIG. 8 is a schematic illustration of a latch mechanism 100 according to a second embodiment of the invention. The latch mechanism 100 has the same structure except that the support member 112 is omitted. Thus, in this embodiment, the core 86 is press into the second shell 10b and the electromagnet 90 is fixed, by virtue of the core 86, to the second shell 10b. Use of the latch mechanism 100 provides the same effects as those by using the latch mechanism 32.

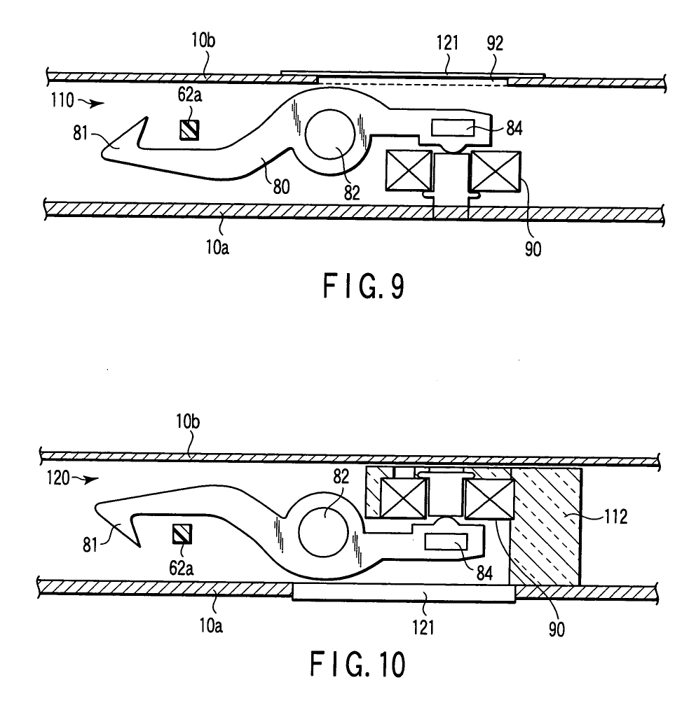

FIG. 9 is a schematic illustration of a latch mechanism 110 according to a third embodiment of the invention. The latch mechanism 110 has the same structure as the latch mechanism 100 except that the electromagnet 90 is provided in the first shell 10a and the opening 92 is formed in the second shell 10b. Use of the latch mechanism 110 provides the same effects as those by using the latch mechanism 100.

FIG. 10 is a schematic illustration of a latch mechanism 120 according to a fourth embodiment of the invention. The latch mechanism 120 has the same structure as the latch mechanism 32 except that a resin member 121 is provided at the position of the opening 92. The first shell 10a is made of non-magnetic material 121 in the region to which the permanent magnet 84 is moved. This prevents the permanent magnet 84 from being affected by an undesired magnetic force when coming close to that region, and provides the same effects as those of the above-mentioned embodiments. Further, it is unnecessary to provide the sealing member 131 to cover the opening 92.

The invention is not to be limited to the above-mentioned embodiments. The invention may be embodied by modifying the components without departing from its essential characteristics. The invention may be embodied in various forms by combining the components disclosed in the foregoing embodiments. For example, some components may be deleted from all components of the embodiments. Components used over different embodiments may be combined.

For example, the number of the magnetic disks 20 is not limited to one. The disk may be increased at need. The head is also not limited to one, and may be increased if necessary. The magnetic disk is not limited to 0.85 inches, and may be 1.8 or 2.5 inches.

What is claimed is:

1. A disk apparatus comprising:
a housing at least partially made of magnetic material;
a disk-shaped medium provided rotatably in the housing;
a head to record and reproduce information on/from the medium;
an actuator to move the head along the medium;
a latch mechanism to lock the actuator at a retreated position to hold the head at a position away from the medium, wherein the latch mechanism has a latch arm provided movably between a first position to lock the actuator at the retreated position and a second position to allow movement of the actuator from the retreated position;
a permanent magnet fixed to the latch arm;
an electromagnet to move the latch arm between the first and second positions, the electromagnet providing a controllable magnetic field adjacent the permanent magnet; and
an opening formed in a region of the housing adjacent the permanent magnet.

2. The disk apparatus according to claim 1,
wherein the housing constitutes a part of a magnetic circuit of a driving motor of the actuator.

3. The disk apparatus according to claim 1,
wherein the opening is provided with a sealing member to make the inside of the housing airtight.

4. The disk apparatus according to claim 3,
wherein the sealing member is made of non-magnetic material.

5. The disk apparatus according to claim 1,
wherein the housing has a first shell to which the medium and actuator are rotatably mounted, and a second shell which forms an airtight space with the first shell;
the electromagnet is fixed to the first shell; and
the opening is formed in the second shell.

6. The disk apparatus according to claim 1,
wherein the housing has a first shell to which the medium and actuator are rotatably mounted, and second shell which forms an airtight space with the first shell;
the electromagnet is fixed to the second shell; and
the opening is formed in the first shell.

7. The disk apparatus according to claim 1,
wherein the housing has a first shell to which the medium and actuator are rotatably mounted, and second shell which forms an airtight space with the first shell;
the electromagnet is fixed to the first shell through a support member; and
the opening is formed in the second shell.

8. A disk apparatus comprising:
a housing which is at least partially made of magnetic material;
a disk-shaped medium provided rotatably in the housing;
a head to record and reproduce information on/from the medium;
an actuator to move the head along the medium;
a latch mechanism to lock the actuator at a retreated position to hold the head at a position away from the medium, wherein the latch mechanism has a latch arm provided movably between a first position to lock the actuator at the retreated position and a second position to allow movement of the actuator from the retreated position;
a permanent magnet fixed to the latch arm;
an electromagnet to move the latch arm between the first and second positions, the electromagnetic providing a controllable magnetic field adjacent the permanent magnet; and
a region of the housing adjacent the permanent magnet is made of non-magnetic material.

9. A method of eliminating sticking of a locking arm to a housing of a disk apparatus having a disk-shaped medium rotatably mounted in the housing, a suspension having a read/write head for the medium and a magnet forming part of the locking arm, the locking arm serving to release said suspension for permitting said read/write head to access said medium in an operating state and to lock said suspension to prevent said suspension from permitting said read/write head to access said medium in a non-operating state, the method comprising the step of:
providing an opening in a portion of the housing adjacent the magnet.

10. The method of claim 9 further including the step of:
covering the opening with a non-magnetic material on at least the outside of the opening.

11. A method of eliminating sticking of a locking arm to a housing of a disk apparatus having a disk-shaped medium rotatably mounted in the housing, a suspension having a read/write head for the medium and a magnet forming part of the locking arm, the locking arm serving to release said suspension for permitting said read/write head to access said medium in an operating state and to lock said suspension to prevent said suspension from permitting said read/write head to access said medium in a non-operating state, the method comprising the step of:
constructing a portion of the housing adjacent the magnet of a non-magnetic material.
